(19) United States
(12) Patent Application Publication
(10) Pub. No.: US 2016/0082405 A1
(43) Pub. Date: Mar. 24, 2016

(54) FLUID HAMMERS, HYDRODYNAMIC SIRENS, STREAM REACTORS, IMPLEMENTATION OF SAME, AND METHODS FOR TREATMENT OF FLUIDS

(71) Applicant: QUANTUM VORTEX, INC., Bellefonte, PA (US)

(72) Inventor: Max I. FOMITCHEV-ZAMILOV, Naples, FL (US)

(21) Appl. No.: 14/786,867

(22) PCT Filed: Apr. 23, 2014
(86) PCT No.: PCT/US14/35211

§ 371 Date: Oct. 23, 2015

Related U.S. Application Data
(63) Continuation-in-part of application No. 13/869,017, filed on Apr. 23, 2013.

(51) Int. Cl. B01J 19/00; C10G 47/22; G10K 15/04; B01D 21/28; F16K 3/02; G10K 7/06; C10G 15/00; B01J 19/24

(52) U.S. Cl. CPC B01J 19/008; C10G 15/00; C10G 47/22; B01J 19/24; B01J 19/006; B01D 21/28; F16K 3/0218; F16K 3/0254; G10K 7/06; G10K 15/04; B01J 2219/00763; B01J 2219/24

(57) ABSTRACT

A fluid hammer/siren can operate in fast valve mode with no leakage flow. A stream reactor and process for chemical reaction acceleration provides a flow of liquid or gas forming jets, streams, vortices, or walls of cavities/bubbles that collide with each other or with other liquid, solid, or gaseous interfaces with energies (defined as the sum of molecular kinetic plus thermal energy) in excess of a chemical reaction activation energy. Wastewater treatment methods accelerate suspended particles to high velocity in a fluid flow and then decelerate rapidly by stopping the flow for accelerated inertial-force driven separation.

### CROSS-REFERENCE TO RELATED APPLICATION

This application claims the benefit of priority of U.S. patent application Ser. No. 13/869,017, filed on Apr. 23, 2013, the contents of which are incorporated herein by reference.

### TECHNICAL FIELD

The present disclosure relates generally to apparatuses and methods for treatment of fluids. More particularly, the disclosure relates to fluid hammers, hydrodynamic sirens, and stream reactors, implementations of fluid hammers, hydrodynamic sirens, and stream reactors, and methods for treatment of fluids.

### BACKGROUND

Heavy oil in general contains a mixture of hydrocarbons that contain both paraffinic C—C bonds, unsaturated C═C and CC bonds, aromatic rings, C—N, C—S, C—O, C—H and other bonds, each with its own disassociation energy.

Hydrocarbon cracking occurs when the hydrocarbon molecules collide with energies greater than the bond disassociation energy. For example, C—C bond disassociation energy is ˜3.6 eV or ˜350 kJ/mol.

The cracking reaction rate is determined by the Arrhenius equation:

f=zExp[−Eₐ/RT], (1)

where f is the reaction rate, z is the pre-exponential factor (usually experimentally determined), Eₐ is the reaction activation energy (experimentally determined), R is the universal gas constant, and T is the temperature.

The Arrhenius equation in turn is based on Maxwell-Boltzmann distribution F(E) of molecular energies E in any ensemble in equilibrium characterized by a temperature T:

F(E)=2(E/π)^{1/2}(1/kT)^{3/2}Exp[−E/kT], (2)

where k is the Boltzmann's constant.

From the Maxwell-Boltzmann distribution (2) it is evident that at any temperature (no matter how high or low), there will be molecules with energies E>Eₐ, which are high enough to break bonds when the molecules collide. Because the Arrhenius equation is derived by integrating the Maxwell-Boltzmann equation it gives the reaction rate f exponential dependence on both the reaction activation energy Eₐ (which is derived from the bond disassociation energy) and temperature T.

So, according to the Arrhenius equation (1) the disassociation and cracking reactions will take place even at room temperature although the rate of reaction will be vanishingly small. The rate of reaction becomes significant, however, when the average molecular energy E approaches and exceeds the reaction activation energy, Ē≳Eₐ. Due to exponential nature of the Arrhenius equation (1) for almost all chemical processes the reaction rate f doubles (triples, quadruples, etc.) for every 10° C. increase in temperature.

Therefore the most natural way to accomplish hydrocarbon cracking amounts to raising the temperature above some critical point (˜400° C. for most heavy oils) corresponding to the cracking reaction activation energy Eₐ for that particular oil (the cracking reaction activation energy depends strongly on the hydrocarbon molar mass: it is higher for light hydrocarbons and lower for heavy hydrocarbons).

Consequently, all industrial methods for hydrocarbon cracking (such as thermal cracking) rely on high temperature (400-900° C.), which is usually accompanied by elevated pressure (80-1,000 psi). Presence of catalyst such as silica, alumina, or zeolite leads to catalytic cracking and accelerates the reaction while somewhat reducing the temperature and pressure requirements to ˜500° C. and <100 psi accordingly.

As a result, the conventional thermal and catalytic cracking processes are able to convert 90-95% of heavy less valuable hydrocarbons into lighter more valuable ones while generating coke (C), hydrogen (H₂), hydrogen sulfide (H₂S), and other incondensable gases (C₁-C₅) as byproducts.

Unfortunately, coke fowls the process equipment by forming harmful deposits that inhibit heat exchange and clog orifices and pores. Coke also fowls catalyst by coating the catalysts' surface and rendering it inert.

Thus, the fowling due to coke and the requirements for high temperature and pressure increase capital (CapEx), energy and maintenance costs (OpEx) associated with the conventional hydrocarbon cracking technologies. At the moment of writing typical commercial hydrocarbon cracking facilities cost hundreds of millions or even billions of dollars and consume approximately 1 MJ of energy per barrel.

Also, the emission of harmful gases—the byproducts of the conventional hydrocarbon cracking technology—further complicates the deployment of these systems due to their large environmental impact (permits may take years to obtain due to mandatory environmental impact studies, public protests, and other issues associated with the environmental protection).

Fortunately, the high-CapEx/OpEx of the conventional hydrocarbon cracking technology and its significant environmental impact can be reduced by implementing the novel hydrocarbon cracking technologies disclosed herein.

It may be desirable to provide apparatuses that, rather than rely solely on temperature and random collision of molecules moving in chaotically in three-dimensional space (3 degrees of freedom), create conditions for organized streaming motion of molecules in one direction (i.e., 1 degree of freedom) and set them onto a collision course.

In some aspects, it may be desirable to provide fluid hammer designs that generate periodic high-pressure pulses that are extremely beneficial for industrial applications such as chemical reaction acceleration, hydrocarbon cracking, crude oil upgrading, waste water treatment, cavitation, and others.

In some aspects, it may be desirable to provide apparatus for fluid treatment with reduced leakage currents and fast valve operation. These designs and optimizations stem from the water hammer theory and to the best knowledge of the author has never been emphasized or implemented in water hammer or hydrodynamic siren designs disclosed in the prior art, including numerous patent applications [U.S. Pat. No. 6,016,798A, EP19940914252, U.S. Pat. No. 2,009,006,5724 A1] and publications [U.S. 20,100,101,978 A1]. This may be accomplished with designs emphasizing tight clearances to reduce the leakage flow and special flow channel configurations resulting in fast valve operation.

### BRIEF DESCRIPTION OF THE DRAWINGS

FIG. 1 is an illustration of an exemplary dry chamber jet reactor with vapor separation.

FIG. 2 is an illustration of an exemplary wet chamber jet reactor with vapor dissolution.

FIG. 3 is an illustration of an exemplary jet reactor with hardened, heated, or catalyst-enriched wall.

FIG. 4 is an illustration of an exemplary jet reactor application process diagram.

FIG. 5 is an illustration of an exemplary hammer system with magnetic coupling.

FIG. 6 is an illustration of an exemplary hammer siren.

FIG. 7 is an illustration of an exemplary wide-slot multi-channel hammer system.

FIG. 8 is an illustration of an exemplary narrow-slot multi-channel hammer system.

FIG. 9 is a conceptual diagram of an exemplary hammer system application.

FIG. 10 is a conceptual diagram of exemplary self-feeding (A) and externally fed (B) hydrodynamic siren.

FIG. 11 is an illustration of an exemplary hydrodynamic siren with rotor, stator, and impeller.

FIG. 12 is an illustration of an exemplary hydrodynamic siren with rotor, stator, and casing.

FIG. 13 is an illustration of an exemplary hydrodynamic siren with long rotor channels.

FIG. 14 is an illustration of an exemplary cross-section of the rotor-stator-casing section of the hydrodynamic siren illustrating a stator channel shaped as an acoustic horn.

FIG. 15 is an illustration of an exemplary hydrodynamic siren with spherical rotor.

FIG. 16 is an illustration of an exemplary natural separation of suspended solids and emulsified liquid droplets by gravity.

FIG. 17 is an illustration of an exemplary accelerated separation of suspended solids and emulsified liquid droplets by gravity due to water hammer.

FIG. 18 is an illustration of an exemplary oxidization of dissolved toxins in wastewater by way of collapsing oxygen bubbles.

FIG. 19 is an illustration of an exemplary water hammer wastewater treatment system and process.

FIG. 20 is an illustration of an exemplary dual-stage water hammer separation and oxidization wastewater treatment process.

FIG. 21 is an illustration of an exemplary down-hole siren operation.

FIG. 22 is an illustration of an exemplary above-ground siren operation.

### DETAILED DESCRIPTION

Reference will now be made in detail to specific embodiments or features, examples of which are illustrated in the accompanying drawings. Generally, corresponding or similar reference numbers will be used, when possible, throughout the drawings to refer to the same or corresponding parts.

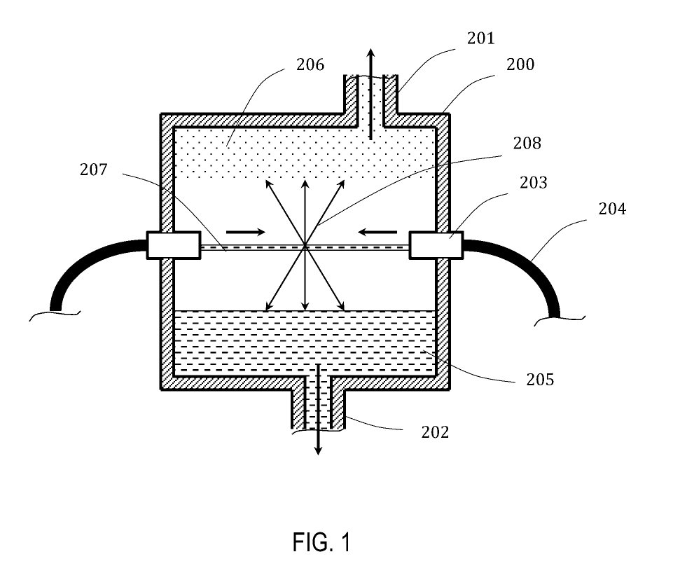

FIG. 1 illustrates an exemplary apparatus for cracking fluid molecules at ambient temperatures (i.e., without necessarily heating the fluid). In FIG. 1, a ‘dry’ jet reactor design according to the aforementioned principles is shown. The reactor chamber 200 is equipped with two or more axially aligned opposing zero-degree nozzles 203. The conduits 204 may supply liquid hydrocarbons under high pressure to the nozzles 203 creating high-velocity streams 207 colliding in the center of the reactor and forming a collision zone 208. The colliding jets will produce both vapor 206 and liquid 205, which can be collected separately via the vapor outlet 201 and the liquid outlet 202 (the separation of the vapor 206 from the liquid 205 may be beneficial for distillation of light hydrocarbons resulting from the cracking reactions originating from the jet collision zone 208).

In the collision zone 208 the hydrocarbons will undergo an accelerated cracking reaction if the sum of kinetic and thermal energies K(V) and E(T) of the colliding molecules is greater than the activation energy Eₐ of the reaction in question:

K(V)+E(T)≳Eₐ. (3)

For the sake of consistency all energies are energies per mole K(V), E(T) and Eₐ are energies per mole.

Applying this simplistic model to the configuration with two colliding jets shooting at each other with velocity V we can compute K(V) as:

K(V)=M₁V²/2+M₂V²/2 (4)

where M₁ and M₂ are the molar masses of the colliding molecules.

Assuming that M₁ and M₂ are the same we can derive the required jet velocity from the equations (3) and (4) as:

V=[(Eₐ−E(T))/M]^{1/2} (5)

At low temperatures we can neglect the thermal energy contribution (E(T)<<Eₐ). Thus, for C₈₀ paraffin (Eₐ=200 kJ/Mol, M≈1 kg/Mol) at room temperature we obtain the equivalent stream velocity V≈450 m/s.

Clearly the increase in the jet velocity V increases the reaction rate and makes the cracking reactions possible even at relatively low temperatures. The reaction temperature reduction has an immense practical importance as it leads to the reduction in formation of coke and incondensable gases (coke and gas production grows exponentially with temperature). In fact the tests conducted by our company at temperatures of 200-300° C. revealed no measurable quantities of coke, asphaltenes, or incondensable gases.

Note that the activation energy Eₐ in the equation (3) is dependent on the reaction of interest, i.e. C—C bond disassociation energy is different and much lower than C═C bond or aromatic ring disassociation energy.

Also, removing cracking products and light hydrocarbons is necessary because light molecules are typically a lot more numerous than the heavy ones and they will effectively shroud the heavy molecules thus absorbing and dissipating the collision energy and preventing the cracking. Therefore, the input stream to the reactor 200 has to contain predominantly heavy hydrocarbons. Otherwise the cracking may be ineffective or be quenched completely.

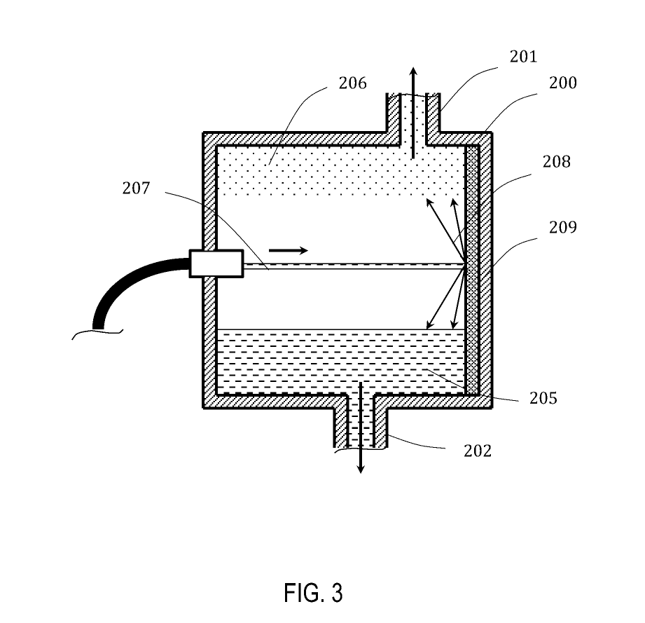

For viscosity reduction applications, however, it is beneficial to keep the cracking products dissolved in the feed as shown on FIG. 3. In this scenario the collision of jets occur in the flooded (‘wet’) reactor chamber 200 and the cracking products remain in solution. The processed feedstock enriched with cracking products (which are predominantly viscosity-reducing lighter hydrocarbons) flows out of the reactor via the outlet 202.

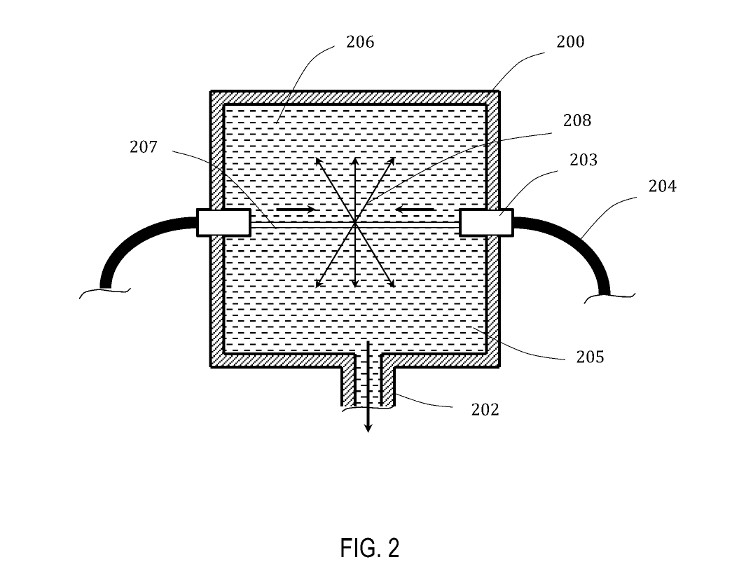

In another embodiment of the reactor shown on FIG. 3, one or more jets 207 collide with the wall 209. The wall can be heated, hardened, and enriched with catalyst (such as zeolite, alumina, silica, acid, etc.). The vaporized cracking products 206 can be allowed to escape via the outlet 201. Alternatively a ‘wet’ reactor design similar to the one shown on FIG. 2 can be used.

In yet another embodiment of the reactor the colliding jets can be enriched with micron-sized hydrogen (H₂) or hydrogen donor gas microbubbles that promote cavitation and hydrogenation for saturation of the unsaturated olefinic bonds formed as a result of the C—C bond disassociation.

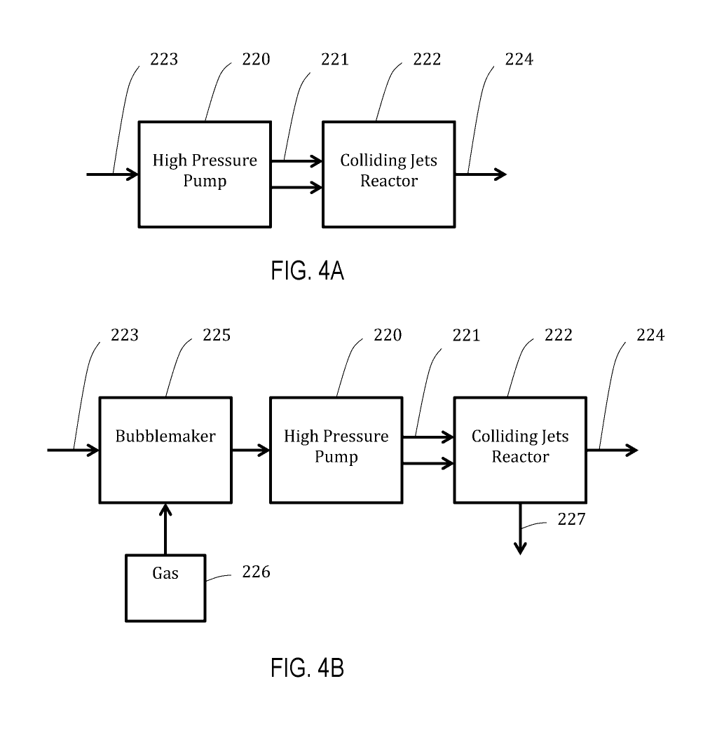

High-level diagram of the simplest jet reactor application process is shown on FIG. 4A: the feedstock 223 is supplied via a high pressure feed pump 220 to the multitude of jets 221 colliding in the reactor ‘wet’ 222 producing the upgraded (e.g. cracked) product 224.

FIG. 4B illustrates operation of the reactor with the microbubbles. The raw feedstock 223 is first supplied to the bubblemaker 225, which is connected to the gas supply 226. The bubblemaker 225 enriches the feedstock 223 with micron-size microbubbles. The high-pressure feed pump 220 supplies the bubble-enriched feedstock to the plurality of jets 221 colliding within the ‘dry’ reactor 222. From the reactor 222 one can remove the evaporated cracking products 227 and the processed liquid feedstock 224.

Both configurations shown on FIGS. 4A and 4B can be ‘dry’ or ‘wet’ reactors.

It is important to note that the disclosed jet reactor can be used to accelerate arbitrary endothermic/exothermic reactions of both synthesis and lysis type as long as the conditions defined by the equation (3) are met. The example of hydrocarbon cracking was chosen solely for illustrative purposes.

Last but not least, the jet reactor can take various shapes. For example, the feedstock can be either gas or liquid. The gas or liquid medium can be accelerated in channels of a hammer device (discussed in more detail below). The medium is accelerated to high flow velocity when the rotary gate of the hammer (or the rotor of the siren) admits flow; then the high-velocity flow is abruptly stopped as the flow collides with the rotary gate of the hammer (or the rotor/stator blank of the siren) as the hammer/siren modulates the flow. Assuming that the flow velocity and the medium temperature satisfy the equation (3) chemical reactions will be accelerated.

Another embodiment of the jet reactor is possible in a fluid flow device engineered to create vortices with maximum rotational velocities satisfying the equation (3). The vortices in general and Rankine vortices in particular can be created by any combination of toothed or pegged rotors designed to create turbulence in fluid (i.e. rotors where the rectangular rotor teeth or round rotor pegs protrude perpendicular to the rotor plane and substantially parallel to the rotor axis of rotation).

Cavitation could be yet another embodiment of the disclosed principle: when cavitation bubbles collapse the bubble walls are accelerated inwards until the collapse is arrested by the compressed gas within the bubble. Chemical reaction acceleration according to the disclosed principle will occur when the maximum bubble wall velocity satisfies the equation (3).

Regardless of the specific implementation of the disclosed invention—be that the colliding jet, the hammer, the siren, the vortex, or the cavitation reactor—the main advantage of the disclosed invention is the reaction acceleration by virtue of high-velocity motion along a single degree of freedom. When this organized motion leads to collision it creates transient high-temperature/high-pressure conditions in the collision zone where the jets or the streams of medium collide with each other or with solid, liquid or gaseous interfaces. Given sufficient stream velocity V as determined by the equation (3) the reactor can operate at less challenging temperatures and pressures thus removing the need for significant CapEx/OpEx associated with current industrial reactors that must operate under high temperature and pressure conditions.

According to various aspects of the disclosure, a fluid hammer can be used to treat various fluids. A fluid hammer is a large rapid pressure pulse that is observed in a pipe when the flow is abruptly stopped, e.g. by closing of valve. The hammer effect can occur in any liquid or gas passing through an enclosed flow channel when the flow is suddenly arrested.

For industrial applications a reactor with one or more modulated (i.e. periodically opened and closed) flow channels can produce the hammer effect generating high periodic pressure pulses.

Regardless of specific configuration any hammer system is conceptually equivalent to a modulated valve. A valve with more than one channel and rotary gate is typically referred to as siren.

The desired function of a hammer device is to generate a large sharp pressure pulse (Pₘ). In an ideal hammer (when the flow is completely stopped and there is no leakage) the magnitude of the pressure pulse Pₘ is proportional to the density of the fluid (ρ) and the speed of the flow (v):

Pₘ˜ρv. (6)

In a perfectly rigid hammer system the magnitude of the pressure pulse depends on how quickly the flow is arrested. Therefore there are two limiting cases: fast valve and slow valve approximations.

### Fast Valve

When the flow stoppage time (τ is much smaller than the time it takes for sound to traverse the length of the flow channel (L):

τ<<L/c. (7)

The pressure pulse magnitude is proportional to the speed of sound in the fluid (c):

Pₘ≈ρv c. (8)

### Slow Valve

When the flow is arrested slowly (τ≳L/c) the magnitude of the pressure pulse is proportional to the length of the pipe (L) and inversely proportional to the flow stoppage time:

Pₘ≈ρv L/T. (9)

In reality the leakage flow and the lack of system rigidity (i.e. the flow channel or the valve gate deformations) reduce the amplitude of the pressure pulse. In practice the leakage flow is often overlooked, as no periodic valve system is perfectly tight.

### Fast Valve Hammer

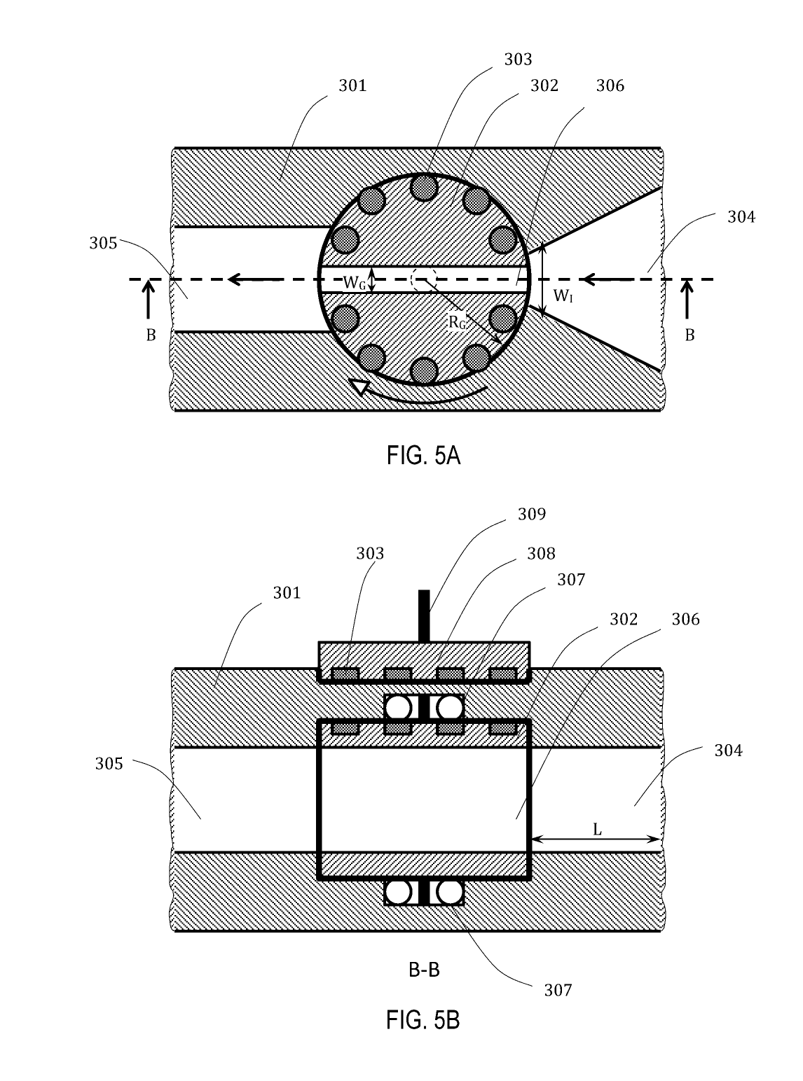

The cross-sections of a fast valve hammer system designed according to the principles disclosed in this patent are shown on FIGS. 5A and 5B.

Fluid or gas flow enters the input channel 304 of length L made in the casing 301 of the hammer system. The rotary gate 302 turns and modulates (opens and closes) the flow periodically. When the rotary gate 302 is open, the flow goes from the input channel 304 through the gate channel 306 and into the output channel 305. The rotary gate 302 is outfitted with magnets 303, is supported by bearings 307, and rotates either clockwise or counterclockwise depending on the direction of rotation of the magnetic coupling 308 that is driven via shaft 309 by an external motor (not shown). Alternatively, the rotary gate 302 can be coupled to an external motor via a mechanical seal.

To maximize the pressure pulse Pₘ by reducing the leakage flow the clearance between the rotary gate 302 and the casing 301 must be minimized. Ideally low friction materials (such as brass for the rotary gate and stainless steel for the casing or carbides for both) should be used in order to achieve clearances on the order of few thousands of an inch or less.

To maximize the pressure pulse Pₘ by ensuring the fast valve operation the width W_{G} of the gate channel 306 must be smaller than the width W_{I} of the input channel 304 (W_{G}<<W_{I}) and relate to the length L of the input channel 304, to the rotary gate diameter R_{G} and the rotary gate rotation frequency F as:

W_{G}<2πR_{G}F L/c (10)

For example, for R_{G}=5 cm, F=100 Hz, L=10 cm, and c=1500 m/s using (10) we obtain W_{G}<2 mm.

Alternatively, the width W_{G} of the gate channel 306 can be much larger than the width W_{I} of the input channel 304 (W_{G}>>W_{I}); then the relationship (10) must hold true for W_{I} instead of W_{G}.

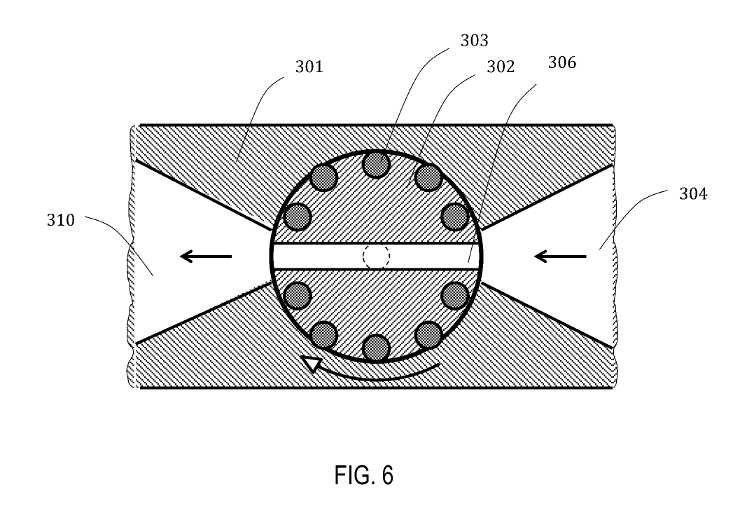

The tapering conical shape of the input channel 304 on FIG. 6A is not required but is beneficial for the backpressure pulse magnitude reduction as the pulse travels from the rotary gate 302 back to the feed pump; the diameter of the widest section of the input channel 304 has to be made large enough to eliminate the damage to the feed pump. Alliteratively or additionally an expansion tank can be used at the input to the hammer system to safeguard the feed pump.

A noteworthy modification to the hammer system is shown on FIG. 6. In this configuration the output channel 305 is replaced with a tapering acoustic horn 310, which could be either conical or exponential in shape. The usage of the acoustic horn in place of the straight output channel will maximize the sound generated by the hammer thus transforming the hammer into a powerful sound source—the siren. The exact shape of the horn should be calculated according to the acoustic horn theory [https://www.grc.com/acoustics/an-introduction-to-horn-theory.pdf] and can be optimized for a particular fluid/gas, flow rate, and rotary gate frequency F.

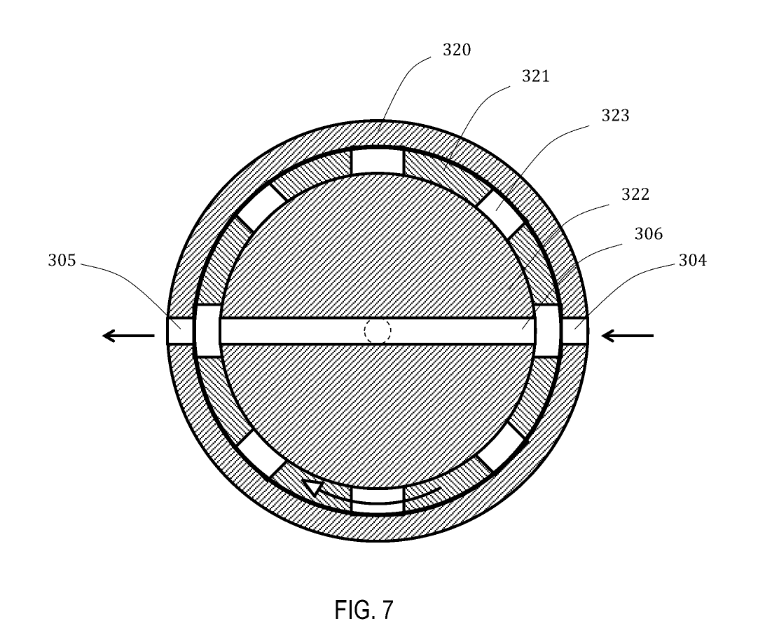

Another variation of the hammer system is shown on FIG. 7. The annular casing 320 has an input channel 304, an output channel 305, and the inner channel 306. The inner annulus 322 is stationary and does not turn. The rotary gate 321 has an annular shape and rotates periodically aligning the openings 323 with the flow channels 304, 305, and 306 thus modulating the flow through the hammer system.

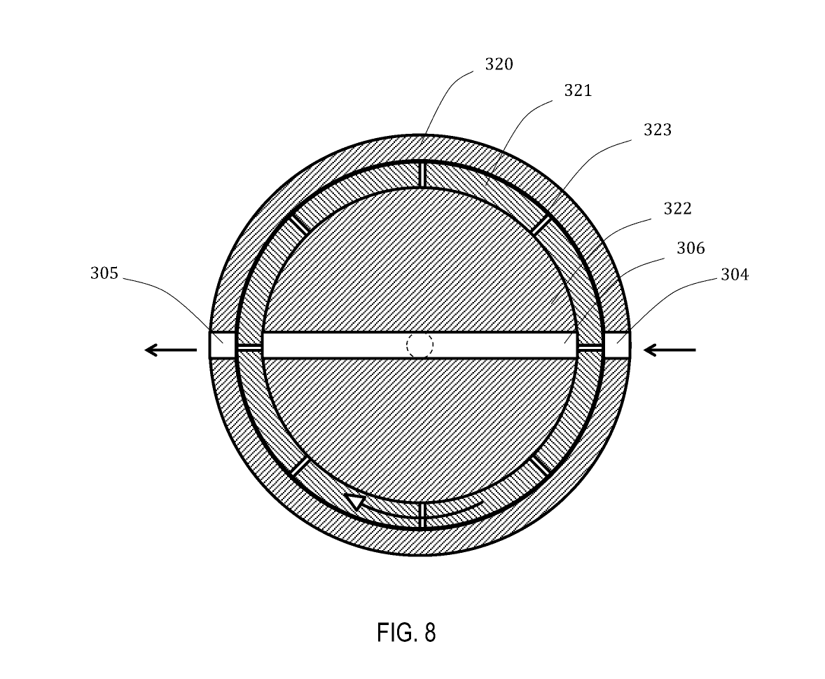

A different variant of the same hammer system is shown on FIG. 8. The two systems depicted on FIG. 7 and FIG. 8 are identical except that the latter has the openings 323 that are much narrower than the flow channels 304, 305, and 306. In both cases, however, the fast valve operation can be achieved according to the equation (10).

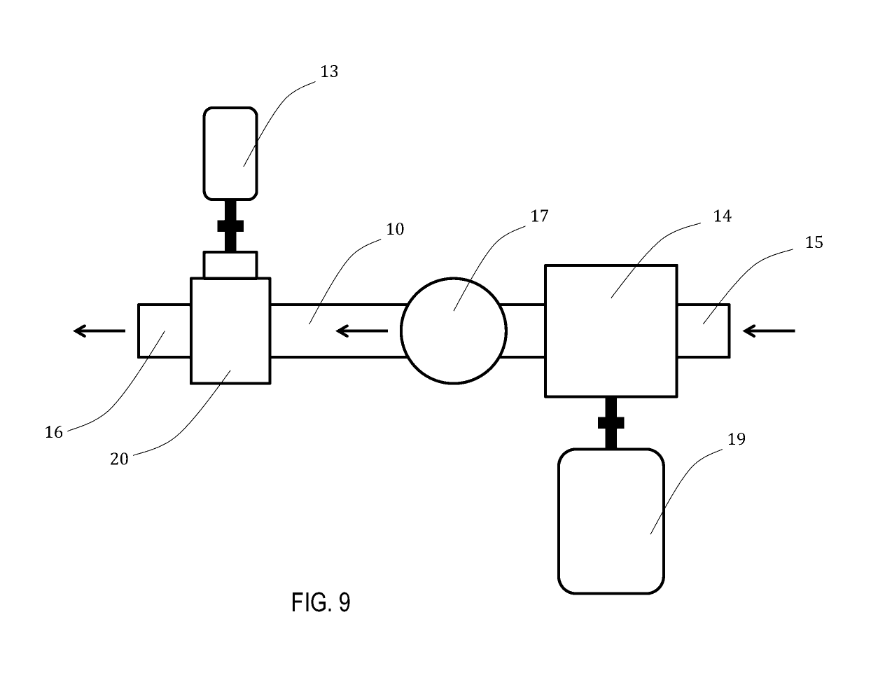

The high-level process diagram of the hammer system application is shown on FIG. 9. The feed pump 14 driven by a motor 19 is coupled to a feedstock inlet 15. The output of the feed pump 14 is coupled to an expansion tank 17, which is connected via pipe 10 to the water hammer system 20 actuated by a small motor 13. Thus the feed pump 14 forces the flow from the inlet 15 through the hammer system 20 and out of the outlet 16.

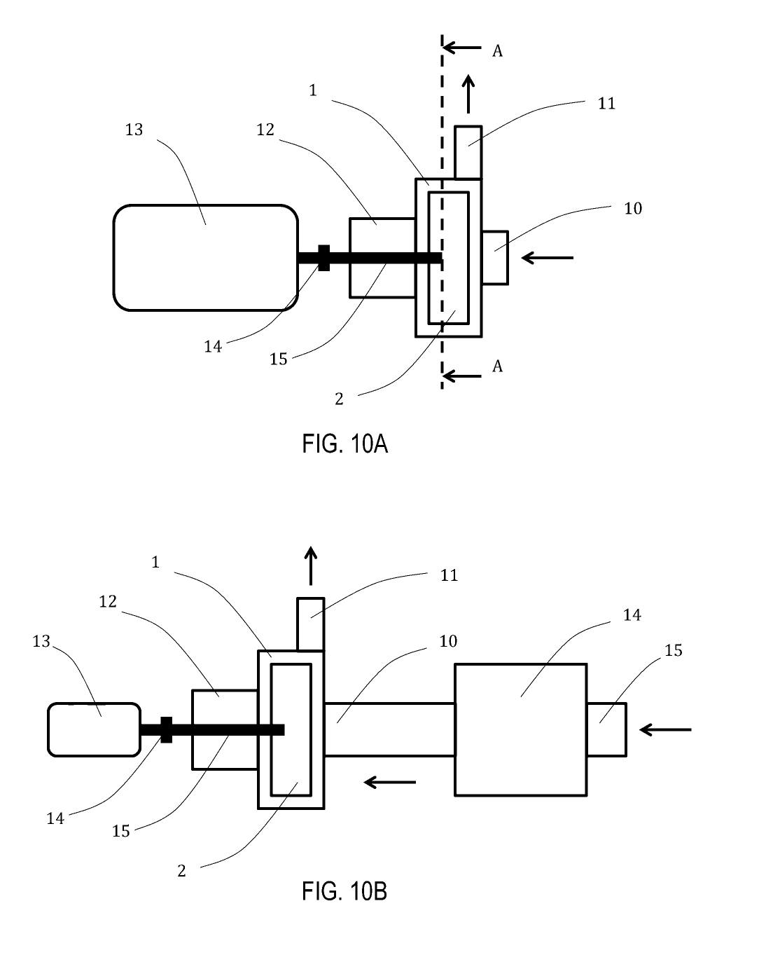

FIG. 10A represents a high-level diagram of a self-feeding hammer siren designed as follows: the reactor casing 1 is housing a rotor/impeller 2 with coupled to a shaft 15 supported by bearings in the stuffing box 12 and driven via a coupling 14 by a motor 13 powerful enough to turn the impeller and to achieve the desired flow rate and pressure. The reactor casing 1 has an inlet 10 and an outlet 11.

FIG. 10B illustrates a variant of the same machine where the rotor 2 has no impeller and the feedstock from the inlet 15 is supplied to the inlet 10 of the casing 1 via a feed pump 14. In this configuration the motor 13 can be quite small as it needs very little power to turn the rotor 2 because the pumping action is accomplished by the external feed pump 14.

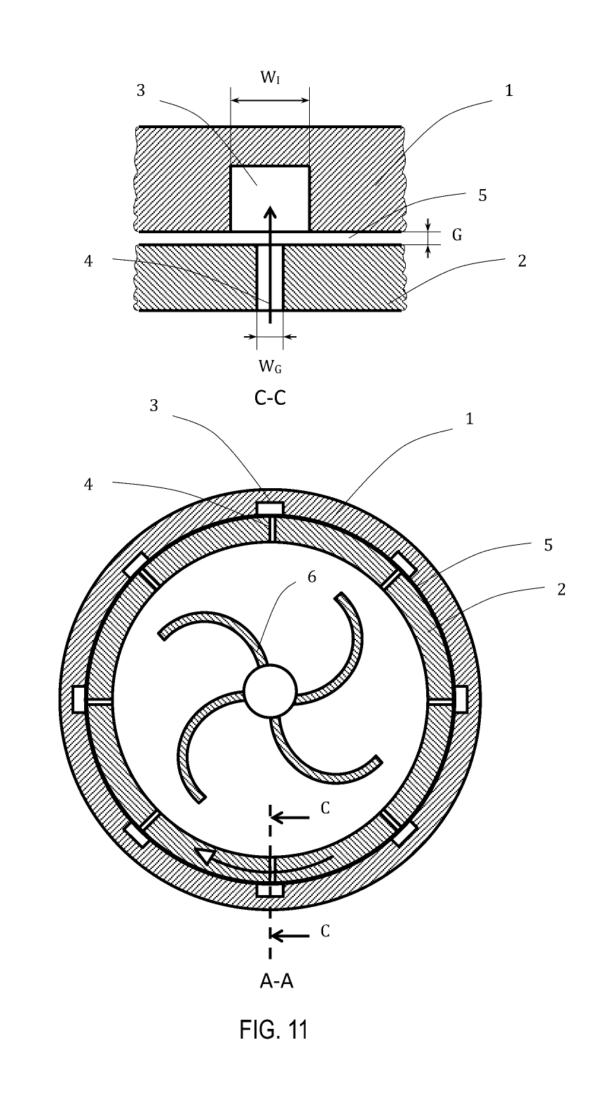

FIG. 11-14 illustrate different possible siren configurations corresponding to cross-section A-A of the siren system from the FIG. 11.

FIG. 11 depicts a siren with channels 3 machined into the casing 1. The rotor 2 is annular in shape and has narrow flow channels 4 and is outfitted with an integral impeller 6 for self-feeding action. The rotor 2 spins with respect to the casing 1 creating hammer events in every channel 4 when the channel 4 is closed by a corresponding blank in the stator 1 and the flow through the channel 4 is abruptly stopped. The efficient operation of the siren is accomplished when the gap 5 between the casing 1 and the rotor 2 is minimized. Ideally the casing 1 and the rotor 2 should be machined from the low-friction materials (such as bronze and stainless steel) such that the gap 5 could be reduced to few thousands of an inch or less to minimize the leakage flow. Also, the fast valve operation can be ensured by choosing W_{G}<<W_{I} and designing and operating the siren according to the equation 5.

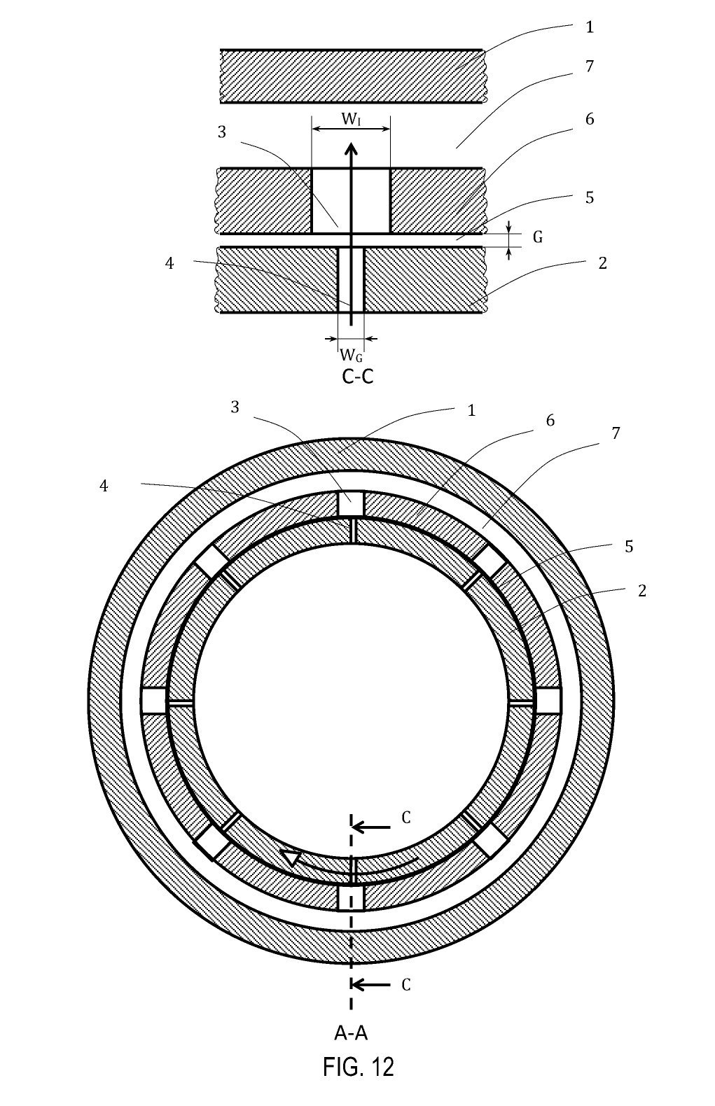

FIG. 12 illustrates another design option for the siren. Unlike the siren on FIG. 11 this siren does not have an impeller (i.e. requires an external feed pump) and thus is not of self-feeding type. Also, the siren on FIG. 12 has a separate inner stator 6 separated from the casing 1 by an accumulation channel 7. The fluid flows from inside of the rotor 2 through the rotor channels 4, then through the stator channels 3, then into the accumulation channel 7, and then out of the casing 1 through an outlet pipe (not shown) plumbed into the accumulation channel 7.

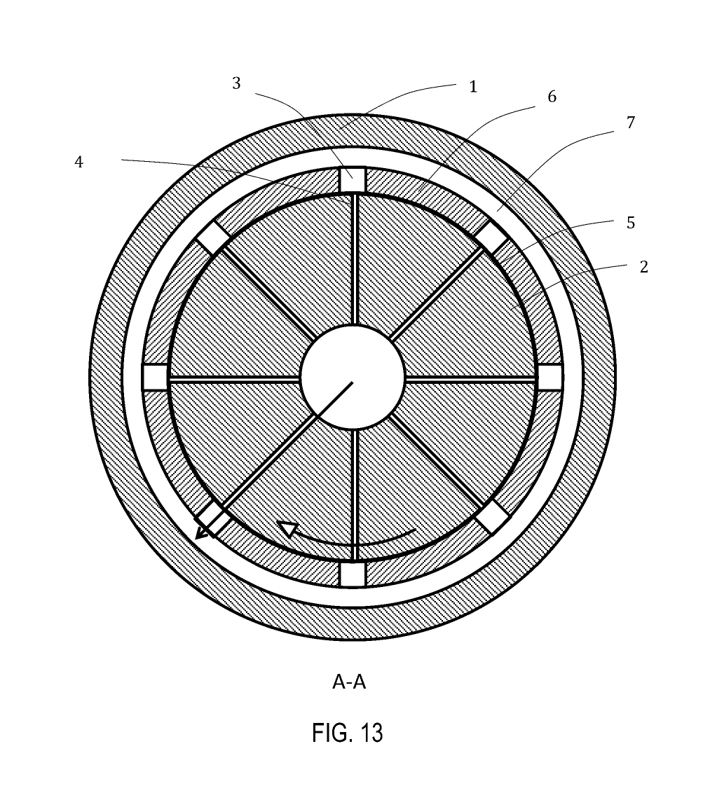

Yet another modification of the siren is shown on FIG. 13. In this embodiment the rotor 2 has narrow flow channels 4 that accomplish centrifugal pumping action by accelerating fluid flowing from the center of the rotor through the rotor channels 4, then through the stator channels 3 and into the accumulation channel 7 between the stator 6 and the casing 1. This design has an advantage of amplifying the pressure pulses Pₘ at the rotor center thus creating a volume of extremely high periodic pressure (sound). In this configuration the total pressure at the rotor center is a sum of pressure pulses generated by each rotor channel 4.

Note that the siren shown on FIG. 13 can be modified by removing the stator 6 and instead machining the channels 3 in the casing 1 similar to the siren shown on FIG. 11.

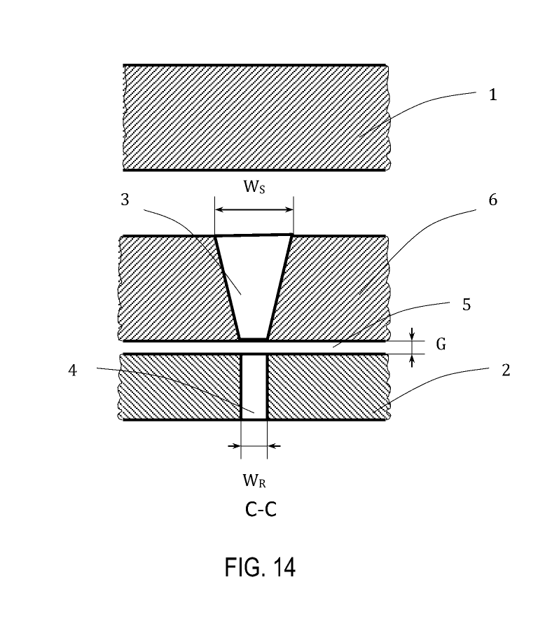

FIG. 14 illustrates a siren modification where the channel 3 in the stator 6 has a shape of an acoustic horn. The horns can be conical or exponential and are necessary to amplify and maximize the sound generated by the siren.

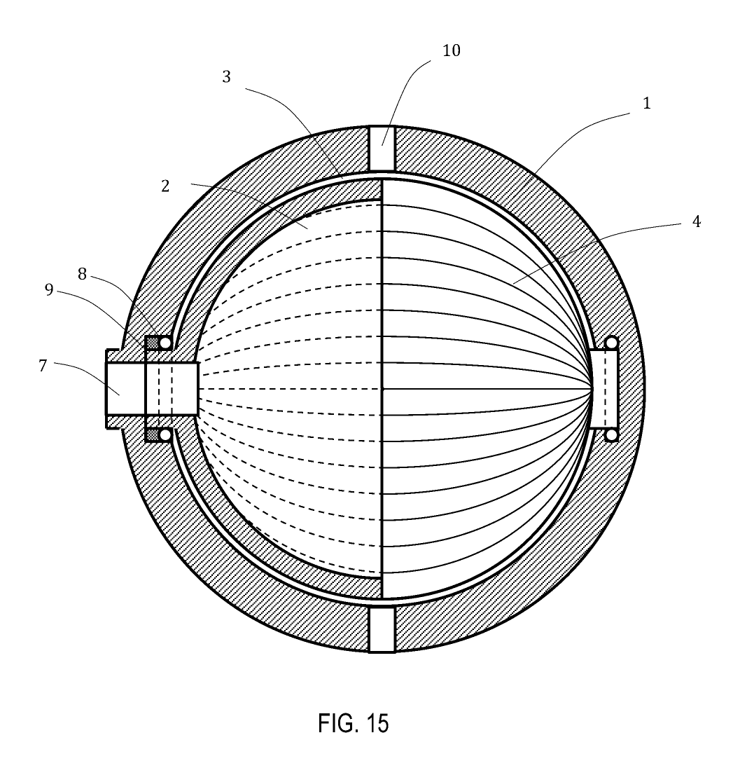

In accordance with the disclosure, FIG. 15 illustrates a siren with a spherical rotor. The cross-section of this siren across the equator will look exactly like the cross-section A-A on FIG. 12 minus the impeller, which is not a part of the spherical siren. In this embodiment the spherical rotor 2 is rotating on the two bearings 8 within the spherical casing 1. The spherical rotor 2 has meridional flow channels 4 cut through its surface that enable the flow from the inlet 7 through the rotor and through the meridional channels 4 into the meridional channels 3 cut within the spherical casing 1, and finally into the circular outlet channel 10 cut around the equatorial section of the casing 1 preserving the integrity of the blanks between the meridional channels 3 in the casing 1. These blanks modulate the flow through the meridional rotor channels 4 thus creating the hammer events. The leakage flow between the channels 3 and the inlet 7 is prevented by the mechanical seal 9. The advantage of such spherical rotor design is the extreme concentration of pressure in the center of the spherical rotor.

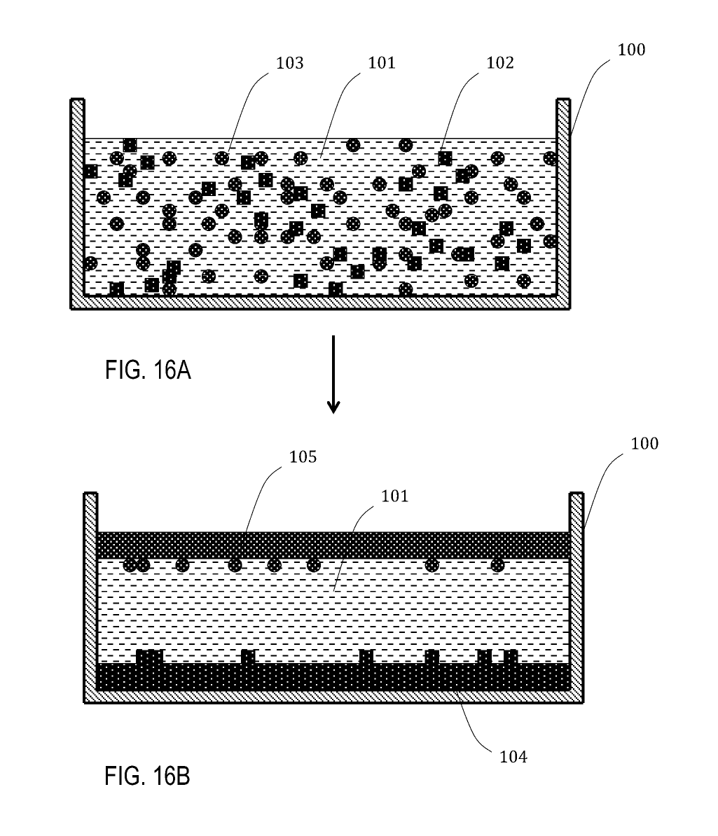

Wastewater typically contains suspended solids, suspended (emulsified) immiscible liquids (like oils), and dissolved solids (like salt, phenols, and other contaminants or toxins). Suspended solids and liquids can be separate naturally by gravity over a period of time in a settlement tank or pond as shown on FIG. 16. The initially homogenous wastewater 101 with suspended heavier-than-water solids 102 and suspended lighter-than-water oil droplets 103 deposited in a settlement tank 100 will eventually separate by gravity into cleared up water with floating at the top oil layer 105 and sunken sediment 104.

The natural settlement approach is widely used by the industry in municipal water treatment plants and in tailing ponds for oil sands production. While this approach requires no energy the necessity to maintain large toxic pools (which in the case of oil sands production can cover immense areas) creates significant environmental concerns due to potential leaks into aquifer.

When rapid settlement of wastewater is necessary artificial gravity via centrifuge can be used. Depending on size of the centrifuge and the rate of rotation a compromise can be achieved between the energy usage, the equipment cost, and the speed of separation. For example, desktop centrifuges rotating at many thousands RPMs can separate blood into plasma and cells by gravity although the initial mixture is highly homogenous and would never separate under ordinary gravity conditions.

For the industrial waste processing the efficiency of large centrifuges is limited by their size: it is exceedingly difficult to create large centrifuges capable of fast rotation and rapid separation of highly homogeneous wastewater and achieve the same degree of performance as high-speed desktop centrifuges. Large industrial centrifuges simply cannot match the performance of desktop devices and thus fail to separate highly homogeneous waste and stable emulsions.

Fortunately, there is another way to create powerful artificial gravity caused by inertial forces: one can accelerate flow of wastewater to high velocity and then abruptly arrest the flow causing floating suspended solid and liquid particles to collide and clamp together as they continue their motion driven by powerful inertial forces.

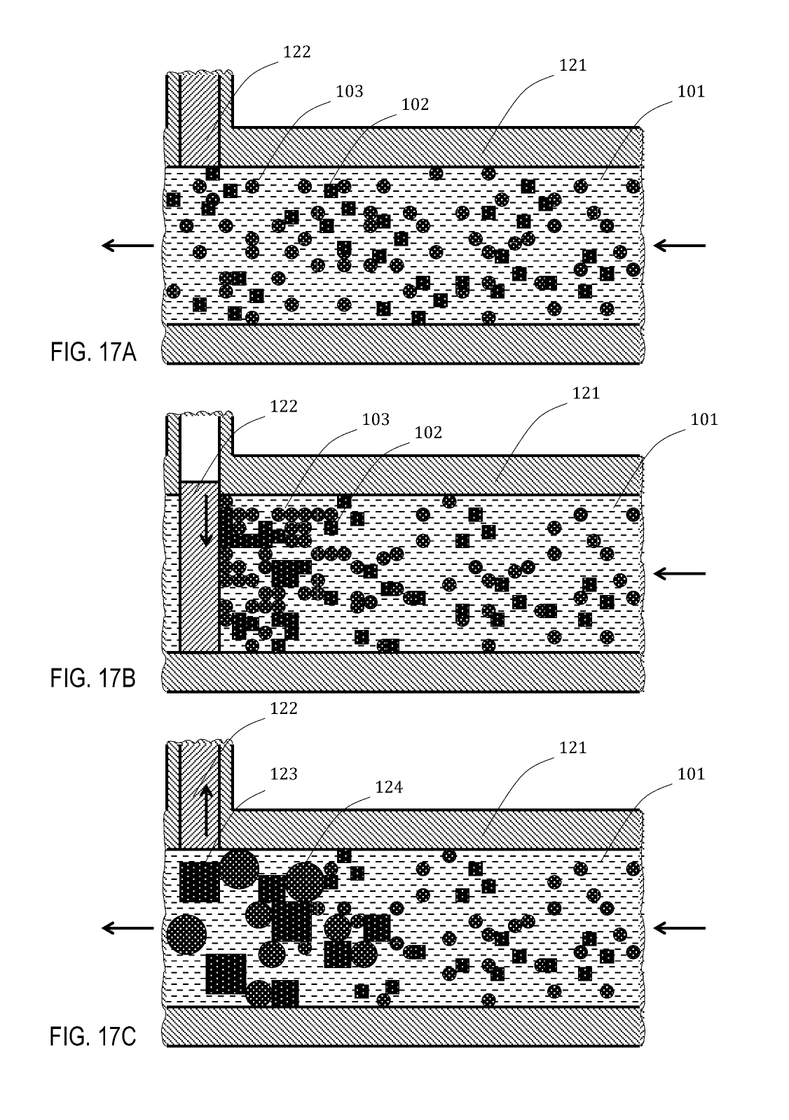

This approach is illustrated on FIG. 17. FIG. 17A shows a cross section of a pipe 121 with wastewater 101 flowing through it at high velocity. The wastewater 101 has suspended solids 102 and suspended immiscible liquid droplets 103. The flow of the wastewater 101 is not restricted as the valve 122 is open.

FIG. 17B illustrates a moment in time when the valve 122 is rapidly closed: although the flow of the wastewater 101 is stopped almost immediately (because the water is incompressible), the suspended solid particles 102 and the suspended immiscible liquid droplets 103 continue their forward motion driven by powerful inertial forces. Thus the suspended solid particles 102 and the suspended liquid droplets 103 collide and pileup at the valve 122 clamping together and forming larger aggregate particles and bigger droplets.

FIG. 17C illustrates a moment in time when the valve 122 is opened again restoring the flow of wastewater 101 through the pipe 121. The flow carries downstream the larger aggregated solid particles 123 and bigger immiscible liquid droplets 124. Naturally, larger solid particles and larger liquid droplets will separate much faster (virtually instantaneously if their size is large enough) under the influence of ordinary gravity in a settlement tank into which the processed water is discharged downstream of the valve 122.

Clearly, to accomplish the efficient gravity separation the flow of wastewater 101 through the pipe 121 must be sufficiently fast and the valve 122 must open and close rapidly (and remain closed without significant leakage flow) in order to create large inertial forces that clump the suspended solid particles and the suspended immiscible liquid droplets together. Because the closure of the valve 122 will create a water hammer, the fast-flow section of the pipe must be very rigid to prevent expansion and the valve closure time T_{c} should obey the ‘fast valve’ condition in order to create the strongest possible inertial forces:

T_{C}<L/c, (11)

where L is the length of the rapidly moving flow and c is the speed of sound (for a not perfectly rigid pipe c is actually the wave velocity, which is lower than the speed of sound in water due to the pipe expansion).

The period of time ΔT_{C} the valve must remain closed (the valve-closed time) must be smaller than 2 L/c in order to avoid column separation due to water hammer, which will reverse the flow of the wastewater in the pipe and thus interfere with the separation process:

ΔT_{C}<<2L/c (12)

Cavitation is another effect that must be carefully controlled and in all probability avoided during the water treatment process. Because cavitation tends to homogenize and break apart the suspended particles due to reentrant jets that form in the proximity of surfaces when the cavitation bubbles collapse, the valve 122 must be controlled such that the excessive pressure drop downstream of the valve never occurs. This can be accomplished by maintaining positive pressure downstream of the valve 122.

Although cavitation is not desirable when clamping of the suspended particles is desired, it can play a significant role in removing and oxidization of dissolved solids. While we can remove the suspended solids via periodic water hammer events the dissolved solid contaminants can be removed only via chemical reactions that result in sediment or gas production (rarely the toxins can be oxidized forming other non-precipitating dissolved solids that are environmentally friendly).

In this regard supercritical water oxidization (SCWO) process is of special interest. The SCWO process has been commercialized for removing (via oxidization) dissolved toxins that cannot be disposed of otherwise. The SCWO process involves heating water to 400-650° C. under pressure in excess of 217 atmospheres (supercritical water). Under these conditions the water disassociates into radicals that effectively oxidize the dissolved toxins without creating dangerous byproducts associated with flame burning oxidization under atmospheric conditions.

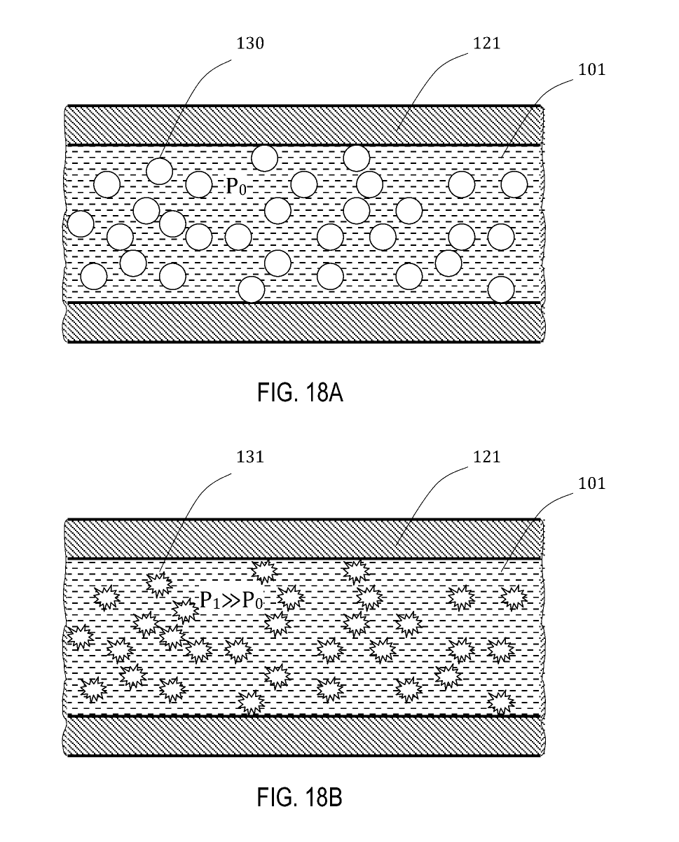

The extremely high temperatures and pressures requires for the SCWO process, however, make it an expensive and energy hungry enterprise. Fortunately, SCWO conditions can be easily achieved in a water hammer device via injection of microscopic (micron-size) oxygen or ozone bubbles—FIG. 18. When the valve 122 is rapidly closed the pipe 121 will experience a rapid pressure rise calculated as:

ΔP=ρc V, (13)

where p is the density of water.

For example, the wastewater stream moving at 100 m/s once brought to an abrupt stop in a fast-valve water hammer will result in a pressure pulse ΔP=1,500 atmospheres. Driven by this strong pressure pulse the suspended oxygen bubbles 130 permeating the wastewater stream 101 will collapse violently resulting in immense temperature rise in the bubble cores 131 creating temperatures in excess of 5,000° C. thus fully ionizing the oxygen, which when in its ionic form is extremely reactive and will oxidize the dissolved toxins it comes in contact with. Thus, by saturating wastewater with vast quantities of microscopic (micron-size) oxygen or ozone bubbles it is possible to create conditions during the water hammer similar to those occurring during the SCWO process and therefore oxidize a great deal of dissolved solids that otherwise cannot be removed.

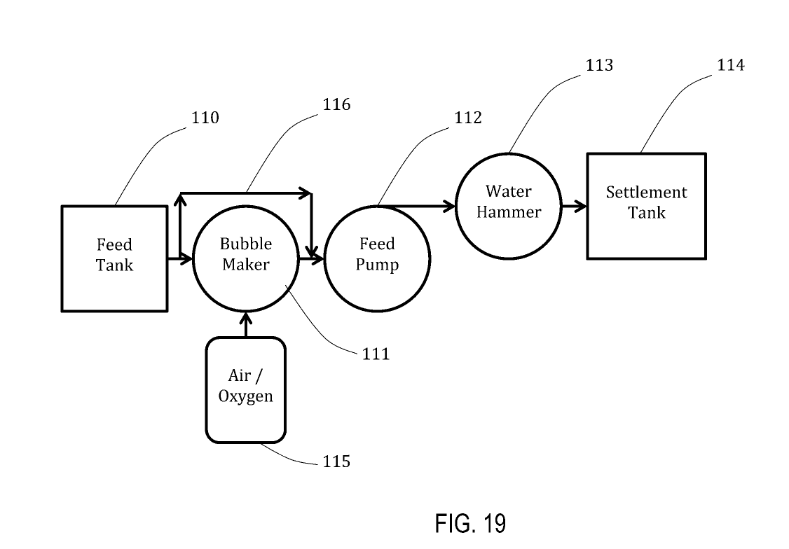

The general water process according to the hitherto disclosed invention is shown on FIG. 19. The wastewater from the feed tank 110 is supplied to the bubble maker 111 connected to the gas supply 115. When oxidization of the dissolved toxins is important the bubble maker 111 will be actively saturating the wastewater with micron-size air, oxygen, or ozone bubbles. When oxidization is not important or the bubbles are undesirable due to interference with the separation process the bubble maker 111 can be simply bypassed via the bypass 116. From the bubble maker 111 or from the bypass 116 the wastewater is supplied via the feed pump 112 to the water hammer device 113 from which it flows into the settlement tank 114 where it undergoes accelerated separation.

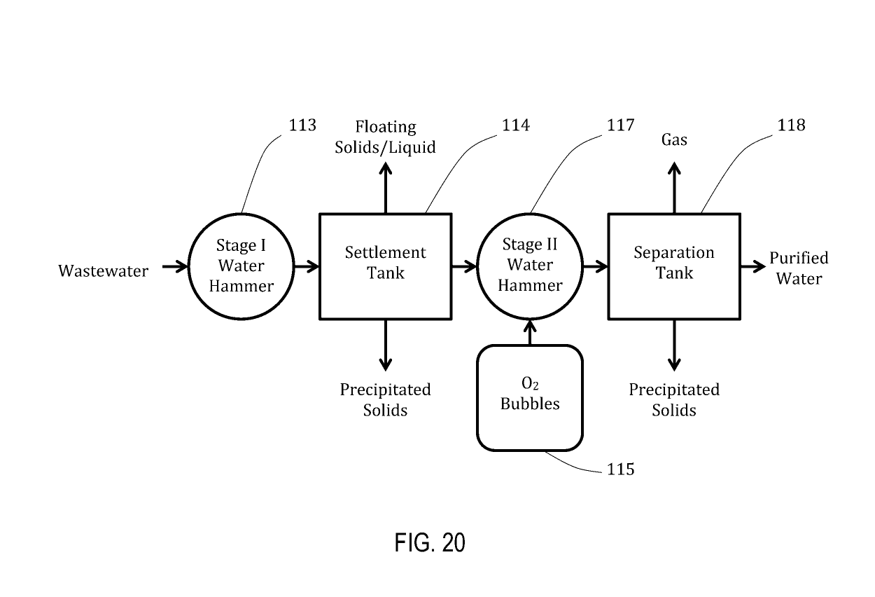

For deeper purification a dual-stage water treatment process can be implemented as shown on FIG. 20. First the wastewater with suspended solids and emulsified liquid droplets is supplied to the Stage I water hammer 113 whose function is to accelerate the separation of the suspended liquids and solids by inertial forces. From the Stage I water hammer 113 the treated wastewater goes to the settlement tank 114 from which the floating and the precipitated particles are removed. The partially purified water devoid of the suspended particles is then saturated with the oxygen micro-bubbles 115 and pumped into the Stage II water hammer 117 where it undergoes oxidization to remove the dissolved toxins. From the Stage II water hammer 117 the purified water is supplied to the separation tank 118 where the solid and gaseous byproducts of the oxidization reactions are removed leaving purified water.

### Well Sonication Hardware

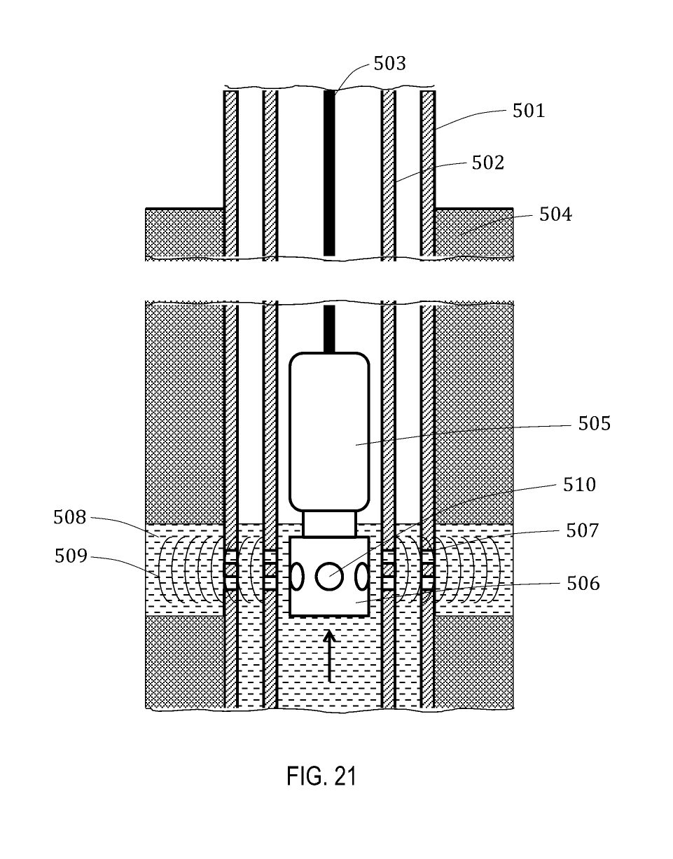

We have developed a variety of high-power acoustic and cavitation apparatuses of both hydrodynamic siren and hammer designs (Patent 1) that are referred hereto as ‘sirens’. Such devices can be produced in form factors small enough to fit standard 6″ or 7.5″ well bore casings and thus could be employed to sonicate the entire well or a particular pay zone within the well as shown on FIG. 21. The siren 506 powered by the motor 505 is lowered via the cable 503 into the tubing 502 within the well casing 501 below ground 504. The siren 506 has the acoustic openings 510 for generation of sound 509 that must be submerged in the well fluids 508 in the vicinity of the perforations 507 of the pay zone to be stimulated.

For a siren to function properly, the entire siren 506 or at least the acoustic openings 510 must be submerged in the well fluids.

For better sound focusing or for a select pay zone stimulation packers can be installed within the tubing 502 to focus the sound.

Power to a siren can be supplied either via an electric cord or via a hydraulic line. In the later case the siren's power drive is a hydraulic high-pressure pump that can be located on the surface of the well; crude oil could act as a hydraulic liquid pressurizing the hydraulic line that powers the siren.

Regardless of the power method the siren can be moved up and down the well to deliver maximum acoustic power to a pay zone of interest. For better energy focusing packers can be used to isolate a pay zone.

The key advantage of our sirens is that they allow delivering 10-100 kW of acoustic power with controllable frequency in the range of a few Hz to tens of kHz, compared to 1-2 kW/fixed kHz frequency possible with conventional piezoelectric or magnetostrictive transducers. Because of much greater power our sirens allow for deeper sonication of the producing formation thus allowing for potentially much larger well output increase.

Another advantage of our siren is unprecedented amplitude of dynamic (acoustic) pressure, which is controllable and could be dialed to exceed 30,000 psi. This dramatic acoustic amplitude enables deeper sonication of the formation since larger amplitude sound can penetrate deeper into material until it is completely attenuated.

### Inline Sonication

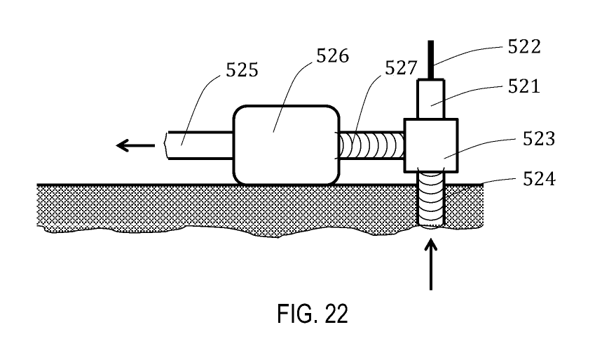

Typically sonication is applied for short periods of time (tens of hours) to boost well production. While such episodic application boosts well production initially the production falls back to pre-sonication figures in a matter of days. Moreover, conventional sonication techniques require transducer lowering into the well, which is a time consuming and potentially disruptive operation for a production well. Therefore a much more economically viable technique is an inline sonication of a production well—FIG. 22. The siren 526 is mounted on surface above ground inline with the suction piping 525 connected to the well 524 via the tee 523 housing the stuffing box 521 and the pump-jack rod 522. The sounds 527 generated by the siren 526 travels downstream along the pipe 525 towards the tee 523 and down the well 524. Because sound reflects very well from metal piping the sound 527 generated by the siren 526 is effectively guided down the well 524 for sonication purposes. The frequency of the sounds 27 can be selected to be low enough by varying the siren's frequency to minimize attenuation while delivering the desired stimulation effect.

In the inline configuration the siren is located outside the well and is directly coupled to the pump. The siren can either operate continuously or under manual control when production requirements require it.

The inline sonication is possible due to high acoustic power (10-100 kW) and relatively low controllable frequency (<10 kHz) generated by our siren, which is sufficient to overcome attenuation en route from the well head to pay zone (attenuation is much higher for high-frequency sound waves generated by conventional ultrasonic transducers).

From the foregoing, it will be appreciated that, although specific embodiments have been described herein for purposes of illustration, various modifications or variations may be made without deviating from the spirit or scope of inventive features claimed herein. Other embodiments will be apparent to those skilled in the art from consideration of the specification and figures and practice of the arrangements disclosed herein. It is intended that the specification and disclosed examples be considered as exemplary only, with a true inventive scope and spirit being indicated by the following claims and their equivalents.

What is claimed is:

1. A fluid hammer operable in a fast valve mode, comprising:
a gate arrangement operable to modulate fluid flow therethrough, the gate arrangement including a moveable member having at least one first opening or channel and a stationary member having at least one second opening or channel, wherein superpositioning of one of the first openings or channels and one of the second openings or channels defines a gate channel having a first width;
an input channel configured to direct fluid flow to the gate arrangement, the input channel having a second width at an interface with the gate arrangement; and
an output channel configured to received fluid flow from the gate arrangement,
wherein the first width is substantially different from the second width to achieve the fast valve mode, and
wherein total leakage area due to clearance between the rotating member and the stationary member is not greater than 10% of a largest cross-sectional area formed by said superpositioning of the first and second openings.

2. The fluid hammer of claim 1, wherein the first width satisfies the equation
W_{G}<2πR_{G}F L/c,
wherein W_{G} is the first width, R_{G} is a radius of the rotating member, L is length of the input channel, F is the rotation frequency of the rotating member, and c is speed of sound in the fluid.

3. The fluid hammer of claim 1 or 2, wherein the rotating member is mechanically or magnetically coupled to a rotational drive member.

4. The fluid hammer of any of claims 1 to 3, wherein the rotating member includes an impeller or turbine arranged such that rotation of the rotating member be powered by fluid flow.

5. The fluid hammer of claim 4, further comprising a feed pump for directing fluid flow to the gate arrangement to rotate the rotating member.

6. The fluid hammer of claim 5, further comprising a backpressure reducing expansion tank between the gate arrangement and the feed pump.

7. The fluid hammer of any of claims 1 to 6, wherein the fluid hammer is configured as an acoustic horn for desired sound generation.

8. The fluid hammer of any of claims 1 to 7, wherein the input channel includes an expansion chamber or an acoustic horn configuration in order to reduce back pressure from the modulating gate arrangement.

9. The fluid hammer of any of claims 1 to 8, wherein the rotating member is spherical.

10. The fluid hammer of any of claims 1 to 9, wherein the rotating member is radially outward relative to the stationary member.

11. The fluid hammer of any of claims 1 to 10, wherein the rotating member is radially inward relative to the stationary member.

12. The fluid hammer of any of claims 1 to 11, wherein the rotating member and the stationary member are contained within a casing.

13. A siren comprising the fluid hammer of any of claims 1 to 12.

14. A chemical reactor apparatus comprising a plurality of colliding fluid streams where velocity and temperature of the streams satisfy the equation
K(V)+E(T)≳Eₐ,
wherein K(V) is kinetic energy of molecules of the colliding fluid, E(T) is thermal energy of the colliding molecules, and Eₐ is reaction activation energy.

15. An apparatus for breaking molecular bonds of a fluid, comprising:
a first arrangement configured to create macroscopic flow of a fluid such that a molecule of said fluid has a velocity corresponding to a bond disassociation energy of said molecule; and
a second arrangement configured to collide said macroscopic flow of said fluid with an obstacle, said collision resulting in molecular collisions having an energy that exceeds said bond disassociation energy of said molecule.

16. The apparatus of claim 14 or 15, wherein the apparatus is configured to increase the pressure and/or temperature of the fluid so as to lower the flow velocity required to correspond to a bond disassociation energy of said molecule.

17. The apparatus of any of claims 14 to 16, further comprising a source of fluid containing a hydrocarbon molecule at a desired cracking temperature, the first arrangement being configured to create macroscopic flow of said fluid such that the hydrocarbon molecule has a velocity comparable with a thermal velocity of the hydrocarbon molecule at said desired cracking temperature, said collision resulting in molecular collisions having an energy that exceeds a disassociation energy of a bond of said hydrocarbon molecule.

18. The apparatus of any of claims 14 to 17, wherein the apparatus is configured to increase the pressure and/or temperature of the hydrocarbon fluid so as to lower the velocity of macroscopic flow of said fluid that creates molecular collisions having an energy that exceeds a disassociation energy of a bond of said hydrocarbon molecule.

19. The apparatus of any of claims 14 to 18, further comprising a chamber providing said obstacle with which the macroscopic flow of fluid is collided.

20. The apparatus of claim 19, wherein said collision occurs in a dry region of said chamber to facilitate vapor separation and cracking product removal.

21. The apparatus of claim 19, wherein said collision occurs in a flooded region of said chamber to facilitate vapor dissolution and for API upgrading or viscosity reduction.

22. The apparatus of any of claims 14 to 21, wherein the obstacle comprises another macroscopic flow of said fluid and/or a physical barrier.

23. The apparatus of any of claims 14 to 22, wherein the obstacle is a hardened wall.

24. The apparatus of claim 23, wherein the wall contains catalyst.

25. The apparatus of claim 24, wherein the wall is heated.

26. A method for reaction acceleration of a fluid, comprising:
creating macroscopic flow of a fluid such that a molecule of said fluid has a velocity corresponding to a reaction activation energy of the reaction of interest; and
colliding said macroscopic flow of said fluid with an obstacle, said collision resulting in molecular collisions having an energy that exceeds the reaction activation energy of the reaction of interest.

27. The method of claim 26, further comprising increasing the pressure and/or temperature of the fluid so as to lower the flow velocity required to correspond to the reaction activation energy.

28. The method of claim 26 or 27, comprising supplying a fluid containing a hydrocarbon molecules characterized by a particular cracking temperature, said step creating macroscopic flow of said fluid such that the hydrocarbon molecule has a velocity comparable with a thermal velocity of the hydrocarbon molecule at said cracking temperature, said collision resulting in molecular collisions having an energy that exceeds a disassociation energy of a bond of said hydrocarbon molecule.

29. The method of any of claims 26-28, further comprising increasing the pressure and/or temperature of the hydrocarbon fluid so as to lower the velocity of macroscopic flow of said fluid that creates molecular collisions having an energy that exceeds a disassociation energy of a bond of said hydrocarbon molecule.

30. The method of any of claims 26-29, wherein said colliding step includes colliding the macroscopic flow of fluid with another macroscopic flow of said fluid and/or a physical barrier.

31. The method of any of claims 26-30, further comprising introducing a dispersing gas into the hydrocarbon fluid prior to said supplying step.

32. The method of claim 31, wherein the dispersing gas includes hydrogen molecules, atoms, or ions, and wherein the hydrogen ions of the dispersing gas bind to a molecule formed by the disassociation of the hydrocarbon bond to prevent recombination of the bond of the hydrocarbon molecule.

33. The method of any of claim 26-30, further comprising introducing micron-sized bubbles of a gas into the fluid.

34. The method of claim 33, wherein the gas is hydrogen or a hydrogen-donor gas, the gas hydrogenating unsaturated bonds.

35. The apparatus of any of claims 14 to 25, wherein the apparatus is a fluid hammer or a siren.

36. The apparatus of any of claims 14 to 25, wherein the apparatus generates vortices and the maximum vortex velocity satisfies said equation.

37. The apparatus of claim 36, wherein the vortices are the Rankine vortices.

38. The apparatus of claim 36, comprising a rotor having pegs or teeth configured to generate said vortices.

39. The apparatus of any of claims 14 to 25, wherein the apparatus is configured to generate cavitation bubbles with maximum wall velocities satisfying said equation.

40. A method for accelerating separation of suspended particle in a wastewater stream via rapid deceleration of the wastewater stream, the method comprising:
directing a flow of wastewater to a fluid hammer having an arrangement operable to periodically close a valve or opening to decelerate said flow, the valve closure time T_{c} providing a ‘fast valve’ condition defined according to the equation
T_{C}<L/c,
wherein L is the length of the rapidly moving flow, and c is the speed of sound, and
wherein and valve remains closed for a period of time ΔT_{C} that avoids column separation, as defined by the equation
ΔT_{C}<<2L/c.

41. The method of claim 40, wherein the fluid hammer comprises the fluid hammer of any of claims 1-12.

42. The method of claim 40 or 41, further comprising introducing oxygen or micron-sized bubbles of a gas into the wastewater to facilitate oxidization.

43. The method of any of claims 40 to 42, further comprising:
directing the wastewater from the fluid hammer to a settlement tank; and
removing, at the settlement tank, floating solids, floating liquids, and/or precipitated solids from the wastewater.

44. The method of claim 43, further comprising:
directing the wastewater from the settlement tank to a second said fluid hammer;
directing the wastewater from the fluid hammer to a second settlement tank; and
removing, at the second settlement tank, floating solids, floating liquids, and/or precipitated solids from the wastewater.

45. Use of a hydrodynamic siren for acoustic well stimulation.

46. The use of claim 45, wherein the hydrodynamic siren is lowered in a well for acoustic well stimulation.

47. The use of claim 45, wherein the hydrodynamic siren is installed above ground.

48. The use of any of claims 45 to 47 for acoustic stimulation during hydraulic fracturing.

49. The method of any of claims 45 to 48, wherein the acoustic siren is configured to unclog pores, remove lime, and/or increases formation permeability.

50. The method of any of claims 45 to 49, wherein an acoustic output of the siren is controllable in power and frequency.

51. The method of claim 50, wherein the output power ranges from 1-100 kW and the frequency ranges from 1 Hz-100 kHz.
